(19) United States
(12) Patent Application Publication
(10) Pub. No.: US 2016/0299951 A1
(43) Pub. Date: Oct. 13, 2016

(54) PROCESSING A SEARCH QUERY AND RETRIEVING TARGETED RECORDS FROM A NETWORKED DATABASE SYSTEM

(71) Applicants: Vinay Bawri, Kolkata (IN); Ritesh Bawri, Kolkata (IN); Malvika Bawri, Kolkata (IN)

(72) Inventors: Vinay Bawri, Kolkata (IN); Ritesh Bawri, Kolkata (IN); Malvika Bawri, Kolkata (IN)

(21) Appl. No.: 15/093,497

(22) Filed: Apr. 7, 2016

(30) Foreign Application Priority Data
Apr. 8, 2015 (IN) 1024/KOL/2014

(51) Int. Cl. G06F 17/30; H04L 29/08; G06F 3/0481; G06F 3/0484

(52) U.S. Cl. CPC G06F 17/30477; G06F 3/0484; H04L 67/02; G06F 17/30489; G06F 3/0481; G06F 17/30522

(57) ABSTRACT

The disclosed invention relates to methods and systems for searching a networked database system, such as data residing on one or more servers to identify and present more direct and objective results relevant to the user's requirements. The present method includes receiving an input from the user specifying the user's requirements. The received input is used to identify one or more context(s) of a search. The search is then conducted over the network based on the identified context(s) or the search term to identify one or more results relevant to the input. The results may be various network resources. The present system navigates through the results and removes the duplicate information. The system extracts important information from the network resources. The extracted information is then merged into more direct and objective answers. These results are then generated and output as a modified network resource.

### CROSS REFERENCE TO RELATED APPLICATIONS

This complete specification is filed in pursuance of the provisional specification having patent application number 1024/KOL/2014 filed at Indian Patent Office on 8 Apr., 2015.

### FIELD OF THE DISCLOSURE

The present disclosure relates to the field of computers, and more particularly to methods and systems for processing a search query and retrieving targeted results from a web-network.

### BACKGROUND OF THE DISCLOSURE

Today, web searching or internet searching is the most convenient way to find information related to a particular subject. Such web/internet searching mainly relies on the web/internet search service providers like Google™ and Bing™ providing a series of Uniform Resource Locaters (URL) or links to various websites, which match the user(s) search query. Although web searching provides a lot of information about a search query related to a particular subject, however, it is a tedious and laborious job to navigate through several links or URLs of different websites in order to find the exact information the user(s) is/are searching for. The search results/links displayed on the first page of the search engine results are usually considered the most relevant. Hence, most of the user(s) often only navigate through the first page of the results displayed by the search engine.

Websites on the Internet are designed by webmasters in order to try and make their links presented on the first page of the search engine. This is done to attract more traffic to a particular website by using the most popular keywords in the content of the webpages on websites. While searching on a search engine, there are lots of instances when irrelevant results also appear on the first page of the search engine. Further, many times the search results/links contain duplicate information already present in other search results/links displayed on that page or on other pages of the search results. Furthermore, sometimes search results/links contain multiple results from the same website on the first page or on other pages of the search results. All the above combinations increase the total number of search results.

When there are hundreds of search results displayed, user(s) have to spend a lot of time browsing each website of the search result and opening each and every URL to find the relevant information the user(s) is/are looking for.

Users often navigate through different websites to find relevant information. However, since the design, font type, font size of each website is different, this variation accordingly can exhaust the user(s) time in their effort to find relevant results.

In recent times, significant advances have been made in web/internet search and in improving the quality of search results/links. However, there is less advancement for providing direct and qualitative answers to a search query and providing targeted web search results to a specific subject or topic. The well-known state of the art technology in this area is Google™ search which is helpful for searching and presenting links to the user. However, Google™ search provides specific search result pages in the form of written content, videos, images, and knowledge graphs, but yet Google™ search is severely lacking when it comes to a comprehensive way of displaying the information and mostly relies on presenting results/information in the form of web links. Hence, the user(s) have to browse through several links to find out the information they are looking for. Moreover, the links contain a lot of duplicate information.

### SUMMARY

Accordingly, a web search tool is required to find only targeted information present on the Internet on different web links and to present all the targeted information in a result other than in the form of web links and in a manner that is easy to read.

There is also a very strong need to find web search results which have a direct relation to the search query. This would save users a lot of time which they might have otherwise spent browsing through information that does not have direct relation to the search query.

Further, when a web search is initiated via a search query then the search engine provides hundreds of web results having different types of information related to the search query. Hence, the user has to open multiple links in order to understand the information provided therein and to make a final objective answer related to the search query. Accordingly, there is also a need to provide more direct objective answers to a search query.

There is also a need to remove duplicate information or results containing duplicate information found in various web links. This removal of duplicate information will be helpful in saving the users' time as only one copy of the unique and relevant information is provided to the user.

When the volume of data is very huge, there can be large number of search results. In such a huge pile of search results, finding relevant information can be difficult and tedious for a user. Hence, there is an imperative need for better and improved Internet search tools, which extract information from various webpages and cull them for presenting to the user in a contiguous format, devoid of web links.

Further, there is a need to present the web search results to the users in a standard design/format that is very easy for users to read and to understand. The said standard design of presenting the web search results will not cause users the pain of viewing and understanding information as present in different web search results each having disparate designs. Further standard designs will be easier on users and will save their time.

Therefore, an objective of the present disclosure is to perform intelligent searching over the Internet by identifying the context of the search term and differentiating between keywords depending on the search requirements.

Another objective of the present disclosure is to provide information extracted from the webpages rather than presenting links to webpages.

Yet another objective of the present disclosure is to cull answers from various websites to provide the best possible answer to the users.

Yet another objective of the present disclosure is to provide objective answers by using calculation field in various websites from one or more websites.

Yet another objective of the present disclosure is to provide objective answers to the user whenever possible.

Yet another objective of the present disclosure is providing a better and more efficient search experience.

These and other objects and advantages of the invention will be clear from the ensuing description.

In light of the above objects, a computer implemented method for searching and presenting the targeted information to the user over the web or the Internet is proposed. Wherein, searching and presenting targeted information over the web/Internet is based on predefined algorithms.

The present computer-implemented method includes receiving an input from the user as an input search term specifying the user's requirements. The said input search term includes any word, alphabet, number, digit, sentence, sign, special character, picture, audio, video or a combination thereof. The received input search term is used to identify at least one search context required to search the targeted web information over the Internet. The said identified search context is capable of searching one or more results relevant to the input search term and presents the said search results in pre-defined format.

In an aspect, the said input search term is provided by the user via various input methods such as but not limited to keyboard typing input, a braille input, a multimedia input, a gesture input, a geo location input of the user, an action input of a computing device or a combination thereof.

Thereafter, the present computer-implemented method navigates and screens the said search results and identifies duplicate content from each of the search results. Thereafter, the said identified duplicate content is removed from each of said search results and just one copy of the information is produced. Further, a redacted content is produced from each of the said search results. Furthermore, a score can be given for duplicate content that was found in more number of web results or websites as compared to duplicate content that was found in a fewer number of web results or websites. The content that is found on more websites may take precedence in display over content that was found in a fewer number of websites. The said contiguous web result is then presented to the user over a graphical user interface of the computing device.

In an embodiment, the search context includes but is not limited to “person”, “product”, “place”, “mathematical formula”, “company name” “music”, “sport/game”, “art”, “literature”, “architecture”, “history”, “geography”, “chemistry”, “physics”, “biology”, and “general term”. The general term further includes content not found in any of the pre-defined categories in related data residing in data repositories and in web networks.

In an embodiment, the present disclosure identifies duplicate content in one or more web results. The said identification of duplicate content is based on analysis and similarity of a sequence pattern. Wherein, the said sequence pattern is a word sequence pattern, a picture sequence pattern, an audio sequence pattern, a video sequence pattern or a combination thereof, a diagram, a sequence pattern, a list format pattern, a series of links pattern, information in a tabular format pattern, a pattern where the headings and subpages of websites match to a certain percentage pattern, a pattern where the words under the said headings, after removing words like a, in, either, match to a certain pre-defined percentage. The duplicate content can also contain different word sequence, picture sequence, audio sequence, video sequence patterns and other afore mentioned patterns. It is generally the case that context and meaning of these sequence patterns are very similar or quite similar and hence it may be inferred that the sequence pattern contains duplicate information. Additionally, the content of one or more web results is also matched and if the content in one or more web results matches up to a pre-defined percentage level then such content is considered to be duplicate.

In an embodiment, a score is given to each web result, wherein such score is given based on number of markers present on a web page. Such markers may be the number of keywords matching with the headings as well as content under the headings of each topic on a webpage. Further, websites have keywords which they provide to search engines so that search engines can understand what kind of information the website possesses or what kind/type of website it is. For example a website like www.amazon.com would have a key string “online shopping for electronics, apparels”, in such a case this too can be used as a marker.

In an embodiment, the desired information is presented to the user in a single contiguous web result which is free from repetition of duplicate content. The relevant information is compiled and presented to the user as an objective solution(s) or information instead of links to webpages. The presentation of search results is in a predefined format depending on the search context of the input search term.

These aspects together with other aspects of the present disclosure, along with the various features of novelty that characterize the present disclosure, are pointed out with particularity in the description of the invention and form a part of the present disclosure. For a better understanding of the present disclosure, its operating advantages, and the specific objects attained by its uses, reference should be made to the accompanying drawing and descriptive matter in which there is illustrated an exemplary embodiment of the present disclosure.

### DESCRIPTION OF THE DRAWINGS

The advantages and features of the present disclosure will become better understood with reference to the following detailed description taken in conjunction with the accompanying drawings, in which:

FIG. 1 illustrates a block diagram of a system (400) which shows the environment in which the invention is implemented, according to an embodiment of the present disclosure;

FIG. 2 illustrates a flowchart of the present computer-implemented method (100) for searching the internet and presenting the search result to the user, according to an embodiment of the present disclosure;

FIG. 3 illustrate a block diagram of the search interface of the present computer-implemented method (100) along with various search context applicable for searching the internet and presenting the web search result to the user, according to an embodiment of the present disclosure;

FIGS. 4 and 4(a) illustrates block diagrams of identifying the duplicated content of the web search results and display a contiguous web result to the user via the user interface, according to an embodiment of the present disclosure;

FIGS. 5(a)-5(b) are flowcharts illustrating a method for determining one or more contexts of the search using the search term(s) input by a user and accordingly conducting the search, in accordance with an embodiment of the present disclosure.

FIGS. 6(a) and 6(b) illustrate an end to end flow diagram of the process for searching, according to an embodiment of the present disclosure.

Like reference numerals refer to like parts throughout the description of several views of the drawing.

### DESCRIPTION OF THE INVENTION

The exemplary embodiments described herein detail for illustrative purposes are subject to many variations. It should be emphasized, however, that the present disclosure is not limited to a particular method and system for searching over the Internet based on predefined algorithms. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced item.

The terms “having”, “comprising”, “including”, and variations thereof signify the presence of a component.

The terms “input search term” and/or “search query” signifies a query/question presented on a computing search engine in any language or format for which a meaning full answer is desired by the user from the Internet or the World Wide Web.

The term “user” signifies a human or a robot or a computing device capable of providing a search query over a web search engine.

The present disclosure provides a method for searching for the desired information over the World Wide Web via the Internet. Further, the present disclosure also provides a method for presenting the targeted information to the user in a single contiguous web result.

It will be apparent to a person skilled in the art that the term “internet” as used herein refers to global networking of millions of computers. Further, a person skilled in the art will appreciate that the term “World Wide Web” relates to a system of interlinked hypertext documents that are accessed via the Internet. A user can surf the Internet and view web pages by using a web browser such as Internet Explorer™, Mozilla Firefox™, Google Chrome™ and the like. The said web pages may contain text, images, videos, and other multimedia content and the user has to navigate between them via hyperlinks.

It will be apparent to a person skilled in the art that the present searching capabilities of conventional internet searching interfaces are limited and have not kept pace with the sheer explosion of the number of digital data that is today present over the World Wide Web. Digital data is increasing day by day all around the world. Whenever, a user search for a specific search term over the internet then the said conventional internet searching interface presents a number of hyperlink search results related to the said search term. Most of the time, such presentation of hyperlink search results is based on the presence of keyword of search term over such hyperlink search results.

Accordingly, the task of searching and locating specific information via the conventional Internet search interfaces are usually time consuming and tedious as the user has to open each and every hyperlink search result to finalize the relevant information as required. Hence, the conventional Internet search interfaces require the user to spend a lot of time for identifying the relevant information from the hyperlink search results.

Most of the time such hyperlink search results provide repeated/duplicate information and the user has to open a new hyperlink search result. This consumes extra processing time of the user as well as the processing time of the computing device and hence is undesirable. This problem of present needs to be technically solved.

A person skilled in the art may appreciate that the present disclosure is capable of searching any type of information over the World Wide Web without navigating the user through hundreds of hyperlink search results. As mentioned hereinabove, the term “targeted” refers to a grouping of information which the system finds most relevant to the user's search term as well as the requirement of the user. The method will now be explained in conjunction with figures.

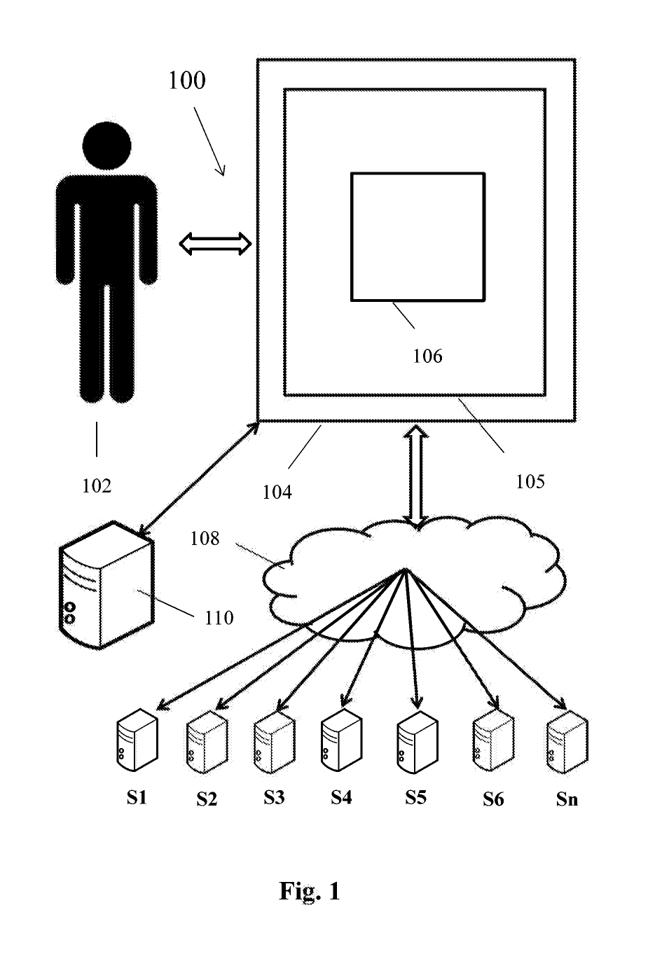

Now referring to FIG. 1, a system 100 has been shown where the implementation of the invention is illustrated with respect to a search environment. FIG. 1 includes a user 102. The user 102 is shown to be using a user computing device 104 such as a PDA (personal digital assistant), a desktop, a laptop, a mobile phone and the like.

The user 102 surfs the Internet through an online platform 108 using the said user computing device 104 through a search interface 106. The user computing device 104 is connected with plurality of servers (S1 . . . Sn) via the online platform 108. Further, the user computing device 104 is connected with a remote server 110. The search interface 106 as provided herein can be an independent search plug-in or a search box over a search engine present on a typical web browser.

The user 102 enters a search term over a computing device 104 through the search interface 106. Thereafter, the present method identifies a search context of the search term and finally a contiguous web result is presented to the user 102 through the computing device 104.

Further, the inventors have incorporated U.S. Pat. No. 8,745,045 granted to the inventors of the present disclosure for the purpose of reference herein to explain the features of the present disclosure.

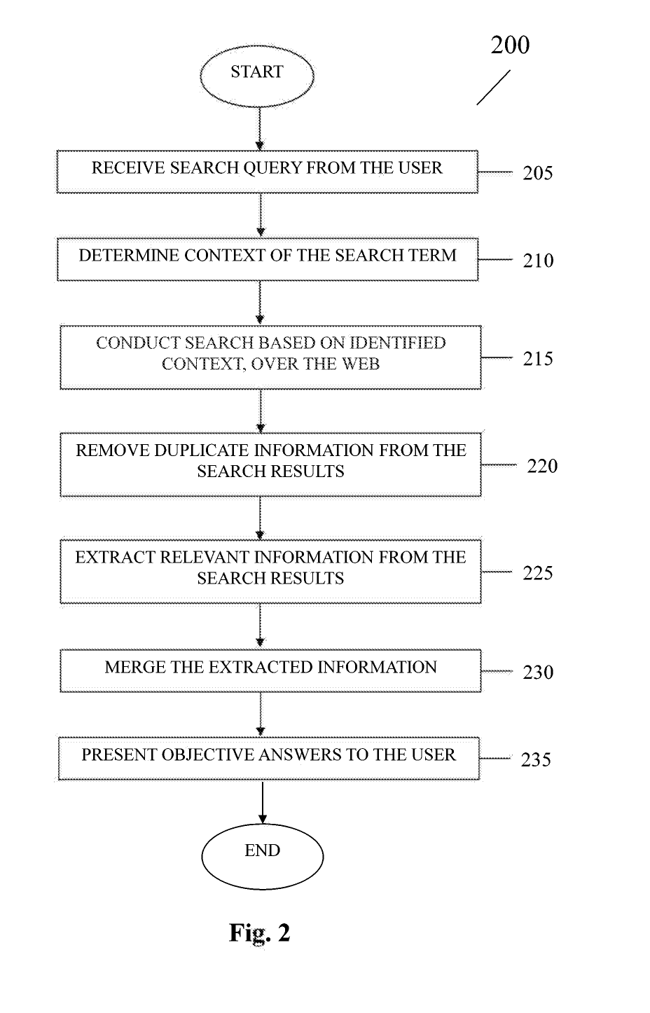

Now referring to FIGS. 2-4(a), the method 200 starts at step 205 where a user enters a “search term” into a search interface 106 as present over the Graphical User Interface (GUI) 105 of the computing device 104.

Accordingly, as per one embodiment of the present disclosure, when the user 102 wants to search the information over the internet via an online platform 108, then the user provides the input search term in the form of a particular keyword(s), wherein the input search term is at least a word, an alphabet, a number, a digit, a sentence, a sign, a mark, a picture, an audio, a video, a special character or a combination thereof. At step 210, the method 200 identifies the search context of the search term from a predefined set of contexts as present over a remote server 110.

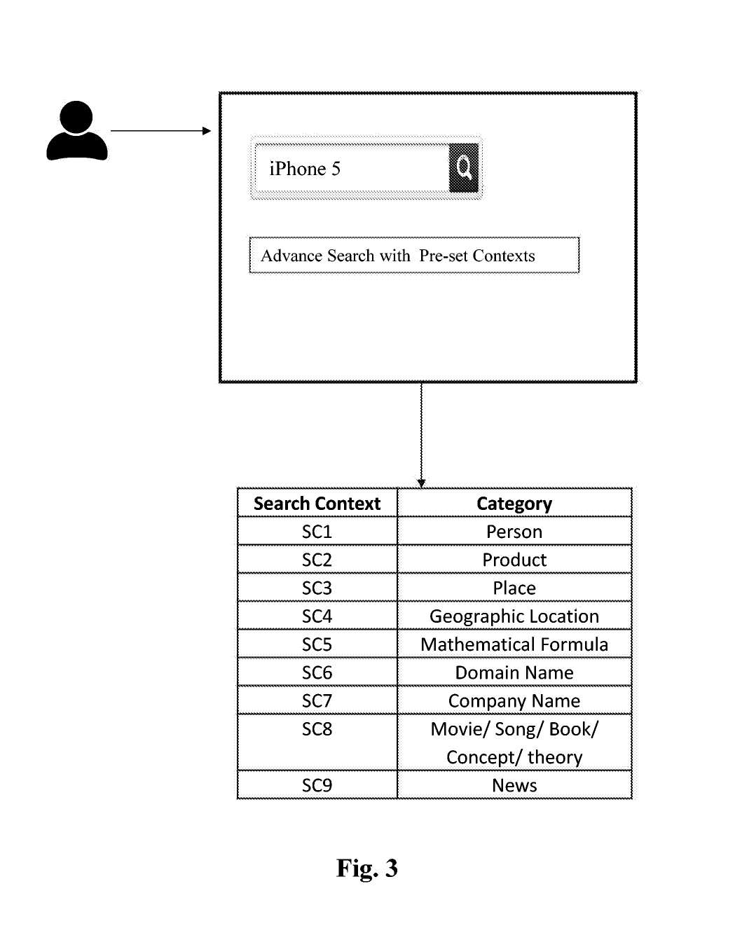

In one embodiment of the present disclosure, as shown in FIG. 3 the user 102 inputs “iPhone 5” as an input search term, the method 200 determines at least one context of the search using the received user input. In such case, the search interface 106 determines the context out of pre-defined contexts as present over the remote server 110.

For example, for input “iPhone 5”, it is determined that the user is looking for information about a product. Hence, in this case, the context of the search term will be a “product”. The said “product” context of the search term is identified because of having pre-defined categories and information in those categories which keeps getting updated regularly. Let us say that such pre-defined categories already include the “iPhone 5” as a pre-defined product. The method 200 has a database of products with which the user(s) search term is matched. This database is updated continuously and dynamically. This database would be similar to the database required to produce Google's knowledge graph.

More specifically, at step 210, the search context related to the search term is identified from at least one of “navigation”, “person”, “place”, “mathematical formula”, “company name”, “product” and “general term”. The general term as a search context further includes “movie”, “concept”, “theory”, “event” “topic” and the like which includes data residing in data repositories and web networks.

At step 215, a search is conducted based on the identified search context of the input search term identified at step 210.

At step 220, the method 200 removes any duplicate content, if found, from the search results.

In one embodiment of the present disclosure, as shown in FIG. 3, if the user 102 enters “iPhone5” as input search term, then the search results will contain various websites containing information related to “iPhone5”. Most of these search results will contain similar information or duplicate content related to the product “iPhone5”.

For example, in such a case, the duplicate content for the product “iPhone5” will contain the technical specifications about the product “iPhone5”. Most of the time such duplicate content reflects the repeated information and whenever, the user 102 opens a new web link then the same reflects the repeated information or duplicate content i.e. technical specifications for “iPhone5”. The duplicate content is identified based on the similarity of sequence patterns, described earlier and elaborated further below, and matching of text where there is a pre-defined percentage match then such similarity of sequence patterns is considered as a cut off. Each search result will have unique content related to the product “iPhone5” such as the user reviews for the product, accessories, availability of product in stores, shipment to a particular location, price of product and other related information. Such, unique content is always important for the user to conclude the final unique answer to his search query. Hence, it is always desirable that the user will get just one copy of the unique content, based on the pre-defined algorithms and in a pre-defined format.

Accordingly, the present method 200 at the step 220 would remove the duplicate content, here in this case, say product specification and retain just one version culled from numerous websites. The identification of duplicate content at step 220 is done by analyzing similarity of a sequence pattern and text pattern over one or more web results.

Further, the sequence pattern includes a word sequence pattern, a number sequence pattern, a sentence sequence pattern, a sign sequence pattern, a picture sequence pattern and a combination thereof.

Resuming the above illustration of “iPhone 5” as input search term, the method 200 at step 220 encounters texts and fields in various websites which are duplicate technical information which includes the screen details, processor details, battery, screen size, etc. This data is identified as duplicate content.

In another example of the present disclosure, if the user enters “IBM” as the input search term, the method 200 of the present disclosure determines at least one context of the input search term. In such a case, the method 200 determines that the input search term “IBM”™ belongs to a company name. In this case the user may not be shown a multitude of information related to their search term “IBM” as search results. The user is directed to a specific website, which is in this case is the official website of the company IBM.

In another example, if the user enters “IBM”™ as the input search term, the method 200 presents the website of the IBM Company over a limited portion of the screen of the user computing device 104. The remaining portion of the screen of user computing device 104 is occupied by other relevant details such as important news related to the company, address of the company, business of the company, financial reports of the company, stock rate of the company and other similar information. In an implementation, the user 102 is either directed to the website of the IBM Company or to other relevant details of the IBM Company which is based on the choice of the user such as cursor selection by the user. Information like address of the company, news, financial reports, and stock prices can be obtained from the company website, pre-defined news sources like Reuters and websites like Yahoo finance etc.

The above given examples are identified in the following manner, the method 200 would look at how many times other users have historically entered the same search term and then clicked on the URL of the IBM company, versus clicking on any other link and not the URL of the IBM company. In case when there is any overwhelming count for users entering the word “IBM” and clicking on the URL of the IBM Company, then the method 200 will take the user 102 directly to the URL of the IBM Company. The method 200 may consider other factors like how many other URLs share the same search term as part of their domain name, the length of the search term in terms of number of words, or how many times the search term is found on the home page of various other URLs.

In another example, where the system accept an input and takes a user directly to the website i.e. if the user 102 enters the input search term “movies” and there are a number of URLs which contain the same input search term, such as www.foxmovies.com, or www.legomovie.com, or moviesrus.com, then the method 200 may not take the user 102 directly to a specific URL. In such a case, the present method could facilitate the user to navigate through all the websites of his choice.

In another case, when there is overwhelming count to suggest that the user has entered an input search term which matches identically or with a few minor variations like a couple of letters shorter, longer, misspelt with the URL of a specific website, then the present method 200 navigates the user 102 to the specific website matching the input search term. In such a case, the present disclosure determines that the user 102 is not looking for the information around the input search term and is looking specifically to browse through a particular website.

In another embodiment, the duplicate content at step 220 is identified during the method 200 by using calculation fields in one or more web results.

At step 225, the method 200 extracts relevant information from the search results. The relevant information now consists of information free from duplicate content from various websites and sources.

At step 230, the relevant information extracted during step 225 is merged. The method 200 merges the extracted information and tries to provide a more direct and qualitative answer to the user 102 at step 235.

This direct and qualitative answer is then provided to the user in a pre-defined format rather than web links. While performing the search, the method of the present disclosure also tries to search for single or multiple objective answers based on various parameters including but not limited to length of the input search term, number of keywords used in the input search term, etc. The method of the present disclosure then provides answers for the input search term in a pre-defined format and style.

In another example, if the user 102 enters “Samsung Galaxy Grand 2” as the input search term then the present web search systems provides the most relevant information in the form of search results. These search results may contain information related to the search term “Samsung Galaxy Grand 2 i.e. technical specifications, price range on different sites and physical stores, customer reviews, shipping cost, shipping speed, product comparison, product warranty, and the like. This information can be obtained from pre-defined websites which match with the product category like amazon.com, and cnet.com etc. Since the present method and system is adapted to determine that the search term matches that of a product i.e. “Samsung Galaxy Grand 2”. Hence, the present method would provide the user 102 with data related to the product “Samsung Galaxy Grand 2” in a pre-defined format.

The pre-defined format will include various combinations of the product criteria such as pictures of the product, price ranges, technical specifications, color options, sizes, current availability of the product, current promotions available for the product, different models of the product, product availability on different ecommerce websites, product availability at physical stores nearest to the user, user ratings for the product as culled from various websites, and product data of other similar products searched and bought by other users after searching and buying the product “Samsung Galaxy Grand 2”.

Further, the pre-defined format also includes information culled from various social network websites such as whether the user's social network has an opinion on the product, whether the user's social network friends or friends of friends bought the product.

Further, the pre-defined format also includes which well-known people are using the product, have an opinion on the product, have tweeted about the product, or posted something in the media, on blogs, in social networks, etc. Such well known people include but not limited to scientists, innovators, academics, scholars, lawyers, doctors, other public figures, celebrities, politicians, business heads, persons popular in social and other main stream media, journalist and/or subject specialists.

The pre-defined format also includes an overall recommendation generated by the system. Such recommendation includes which version of the product the user should buy (if the intent of the user is to buy the product), where the user should buy it from, etc. The recommendation will show the top choices that will be uniquely calculated for the user based on parameters including but not limited to those mentioned above. These recommendations can be calculated by giving a score and combining the ratings from various websites like amazon.com, and cnet.com etc.

The product data of other similar products includes product names along with pictures and specifications and prices of products which have been searched for or browsed and bought by previous users who have used the same search term. This product data of other similar products searched and bought can easily be culled from websites and search engines, for example the Google uses an auto suggest feature which shows variations of the search term like “Samsung Galaxy Grand 2 black”, or from other various social networking websites such as people who searched for “Samsung Galaxy Grand 2” also searched for iPhone, among other things.

In order to find the closest location to the user where the product is available, the present method may first prefer a local website over an international website and/or will look for the local website of an international company in the region/country the user is searching from.

In another example, if the user 102 enters the input search term as “Malcom Gladwell”, the present method determines that the search context is related to a “person” by matching it with a pre-defined database. Hence, the present method provides search results related to a person in a pre-defined format. The predefined format includes but is not limited to biographical and demographic details of the person, friends and relatives of the person, family history of the person, and the like. These details can be extracted from a website like Wikipedia.com. The search result might also include latest photos of the person if available on different websites on the internet, and if applicable and available the search results might also include the latest and most popular videos of the person, latest and most popular audios of the person, latest and most popular books written by the person, education details, employment details, hobbies, activities, etc. Such information can be derived from specific sites like LinkedIn, Facebook, Amazon, Twitter, Wikipedia, YouTube, Blogs, and the like.

Further in such a case, the pre-defined format also includes but not limited to the information that is in the public domain i.e. information from social networks of the “person”. For example, it would include the latest tweets by the “person”, the latest Facebook posts by the “person”, and the like.

Further in such a case, the pre-defined format may also include but is not limited to information that is in the media related to the person.

Further in such a case, the pre-defined format also includes but is not limited to the information on people who the user and the person the user is searching for, know in common. In other words, such information includes mutual friends between the user and the person the user is searching for. Hence, this information facilitates the user of such search term connecting with the person as presented in their search query, with relative ease.

Further, the pre-defined format also include interests, hobbies, activities, places of interest, and the like which is common between the user of such search term and the person name that the user is searching for. This information can be obtained from a website like for example www.facebook.com, and www.linkedin.com

Further, the pre-defined format also includes but not limited to similar education institution attended, similar company worked at, similar industry worked in, and/or similar profession and the like. As mentioned earlier this information can be gleaned from LinkedIn, Facebook, Amazon and other popular websites.

When the present method determines that the search context is related to a person, then the pre-defined format of the present method and system also includes as applicable, the details of books, movies, articles, companies, products as associated with the person of the search context. The pre-defined format also includes the latest news about the person, latest social feed from social networks like Facebook™, Twitter™ and the like. The latest social feed from social networks includes the information such as who are the persons, institutions, or products which are closely tagged along with the person of the search context.

The pre-defined format of the present method further includes the institutions such as schools, colleges, universities and other similar institutions related to the person of the search context which may be culled from websites like LinkedIn. The pre-defined format of the present method further includes the important dates related with the person of the search context. The important dates related with the person of the search context can be the important dates related with the career and personal life of the person such as for a person related to a music band it may be concert dates or the like. The pre-defined format of the present method further includes whether the person of the search context is trending up or down in the web search results.

Hence, the present method provides more direct answers in a pre-defined format to the users search term by culling information from various websites instead of providing web links as results.

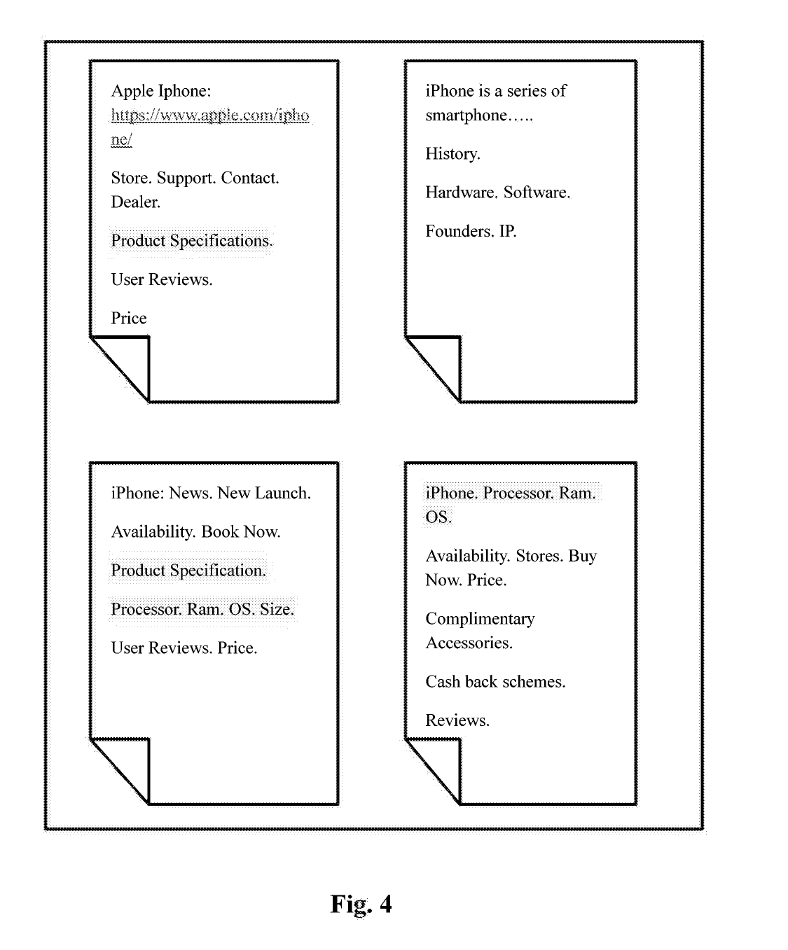

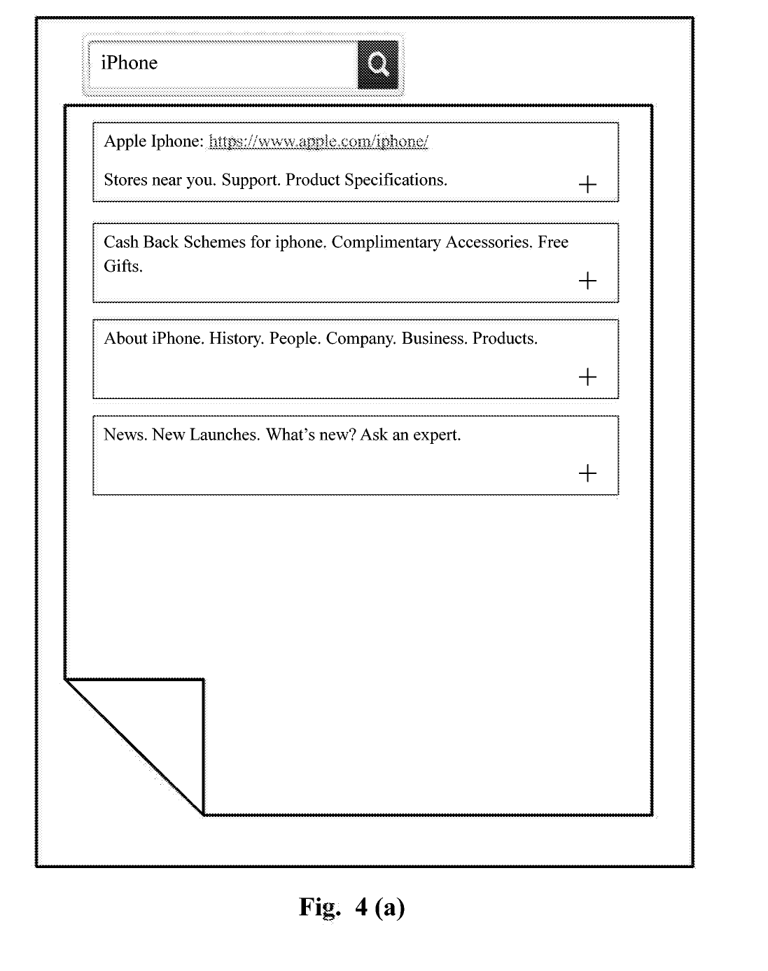

In various embodiments, as shown in FIGS. 4 and 4 (a), the results may be in a pre-defined format. For example, in the case the user 102 searches for “iPhone 5”, the pre-defined format may include, product description, technical specification, reviews from various websites, reviews for authoritative websites or peoples, closest place where the item can be procured or purchased, highest and lowest prices for the product currently on the internet and such said information is culled from listings from sites like eBay and Craigslist, items closely tagged with iPhone 5, like Samsung Galaxy 5, release dates, defects reported, newer and older versions, new and used products and the like.

Moreover, the pre-defined format would have characteristics like same font, font size, design, drop down menus to access different portions of information like rating, reviews, prices etc. and will not show web links to the user. These are various features integrated into the method of the present disclosure.

In one embodiment of the present disclosure, when the user 102 provides an input search term related to a topic such as “best restaurants in san Francisco” then the present method determines that the search context is related to a specific topic. Such search context related to specific topic is based on following criteria:

a) the length of the query which includes more than one disparate words. This is unlike a search query like “Tim Berners Lee” which has three words but the three words are non-disparate and connected as “Tim Berners Lee” is the name of a person;

(b) the search term not matching any pre-defined database;

(c) the search term not having matched any pre-defined category.

Moreover, each and every user has specific requirements with regard to a specific topic. Hence, the present method and system is adapted to provide all the important information of the specific topic with respect to the requirement and situation of the user.

It is very commonly observed that there are many topics on which there is no exact information or very less meaningful information present over the World Wide Web. For example, if a user enters the search term “improving kiln production” and there us very little meaningful information present over the internet and whatever information is available over the internet is not tailored to the requirement and situation of different users. The users query is essentially “how can one improve the production in a kiln which may be for example a kiln in a cement plant”.

However there would be thousands of experts available who would possess knowledge of such specific topics. Hence, the present method and system is adapted to provide important information to a user related to the topic of the search term along with the information of experts on such topic. The information of the experts may include the name, address, phone number or email address of the expert. Moreover, the experts close to the user's location might be provided on the top. The leading experts information is also be provided on the top. The information of the experts is taken from various internet sources or the specific online platform where the experts are registered. Accordingly, the experts of the specific topic are shown in the search results and then the user can contact the expert and can ask the questions of their interest. The method and system of the present disclosure also provides a rating system for each of the expert and the user is also free to rank the experts.

Further, the present system and method may search for experts from various websites and present them to the user along with the search results. Accordingly, the present method and system acts like a human for searching and extracting information from experts or volunteers, which is not available today readily on the Internet. Further, the present method and system compiles information which may be available today in too fragmented manner and thus having no real meaning. The present method thus gives the fragmented information meaning by compiling it and presenting it to the user when the user is searching for such information. Thus the user is able to get information about the experts rather than restricting results to what is available on the Internet. Through this process the user might be able to find information that is not easily available on the Internet but is available in the minds of experts on that topic.

Though the Internet is the most used method of finding information today, yet it suffers from the limitation that only that data can be searched which has been uploaded by websites. There would be boundless other data which some persons/experts are aware of, but the same data is not available on the Internet.

Though the Internet is the most used method of finding information today, yet it suffers from the limitation that only that data can be searched which has been uploaded by websites. There would be boundless other data which persons are aware of, but which would not be on the Internet.

Today advertisers pay search engines whenever the user clicks on their advertisement/paid link. The system would use a novel method where any user can upload a question and answer, or a piece of information, and these would be part of the search results. Here the system may choose a suitable question and answer that a user has uploaded and pay the user for sharing the information. The system would find the best match and directly display the aforesaid information. This would lead to an explosion of information on the Internet, as users will be monetarily incentivized to upload question and answers/information, which then can be searched and displayed.

Though there exist question and answer sites like Quora, they do not suit the current objective as here the user (a) knows the answer to the question as opposed to sites like Quora where the person asking the question does not know the answer (b) is monetarily incentivized to upload question and answers.

The format to upload the information can be made in a user-friendly manner. This would make users who do not want to maintain a website or blog, but have specific answers to questions to upload question and answers/information to share the same which would lead to an explosion of information available. The question and answers can be, for example, “who are the Doctors on call in San Francisco for a medical emergency” and the answer may be a list of Doctors which the user has uploaded. In order to ensure qualitative information, the user has a choice of rating the Q&A.

The answer will be from a user perspective and can be tailored to be as brief or as lengthy by limiting the number of characters the user can enter as an answer. This leads to objective and direct answers or lengthy answers as the case may be thereby leading to more direct, qualitative answers.

Further, the system and method is adapted to pay the person who shared the relevant question and/or answer, or a piece of information related to the user search term. The system would find the best match and directly display the aforesaid information. This would lead to an explosion of information on the Internet as peoples get monetarily incentivized to upload question and answers/information which then can be searched and displayed.

Further, the present system and method uses a predefined user-friendly format to present more direct and objective results relevant to the user's search term. This leads to objective and direct answers or lengthy answers as the case may be thereby leading to more direct, qualitative answers.

To summarize FIG. 2 describes a method 200 for identifying the context of a search term and searching on the basis of identified context search term. At step 205, input search term is entered by a user 102 in the search term box of the user computing device 104. At step 210, the method 200 identifies whether the input search term has a pre-defined syntax as incorporated in the plug-in 106. If the answer is “YES”, search is conducted referring to the contexts such as “person”, “mathematical formula”, “company name”, etc., as in step 215. If the answer is “NO”, the input search term is identified as “general term” as mentioned at step 225 and search is conducted considering the term as “general”. In such case, the method 200 infers the context of the search term as “concept”, “theory”, “questions”, and the like.

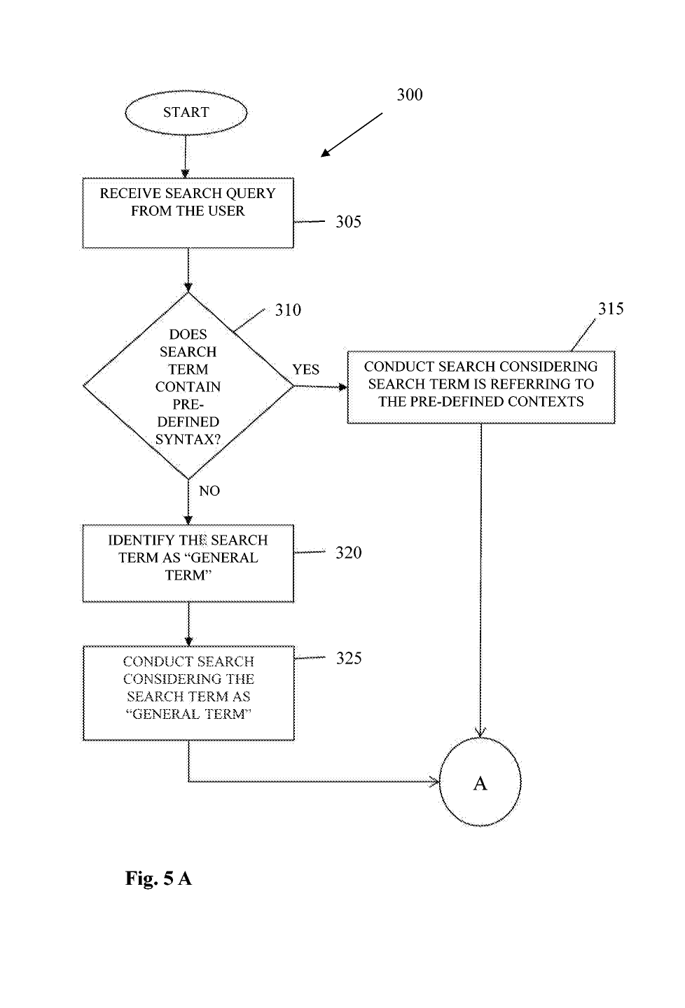

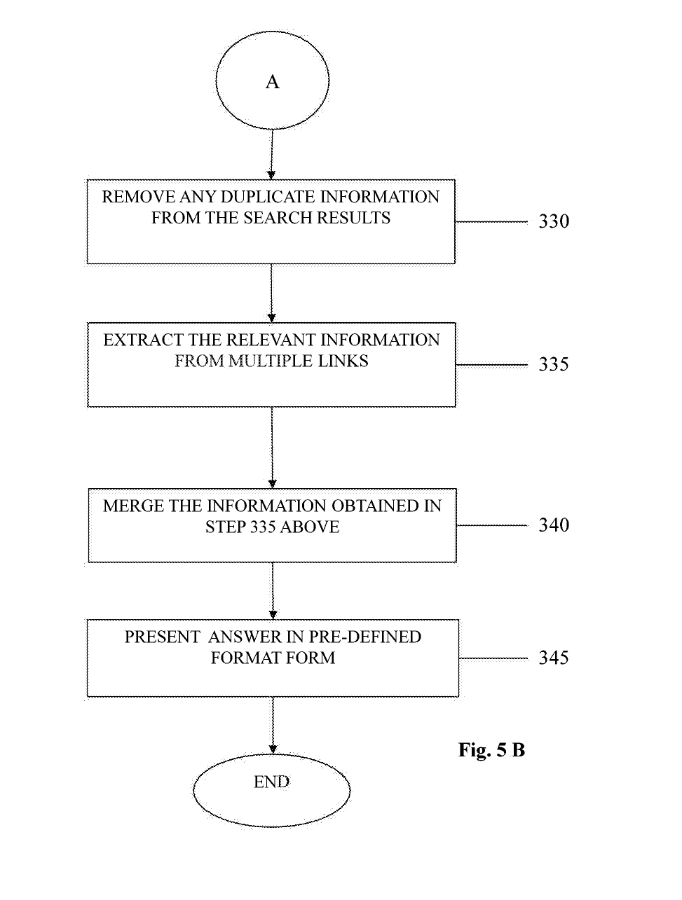

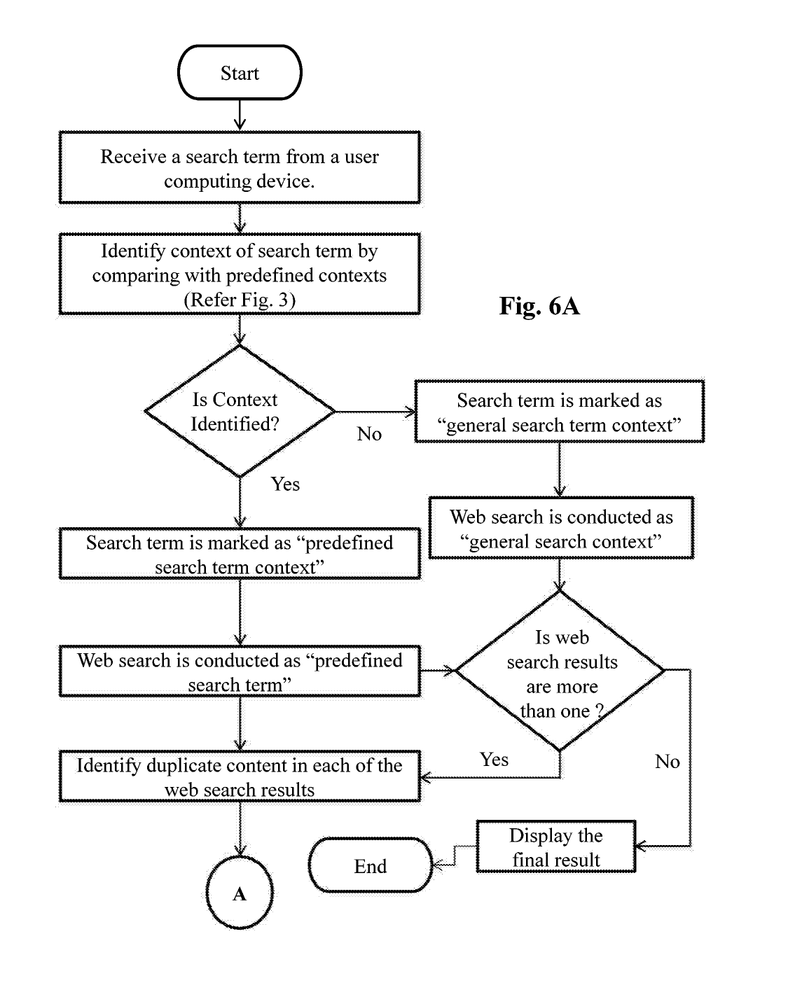

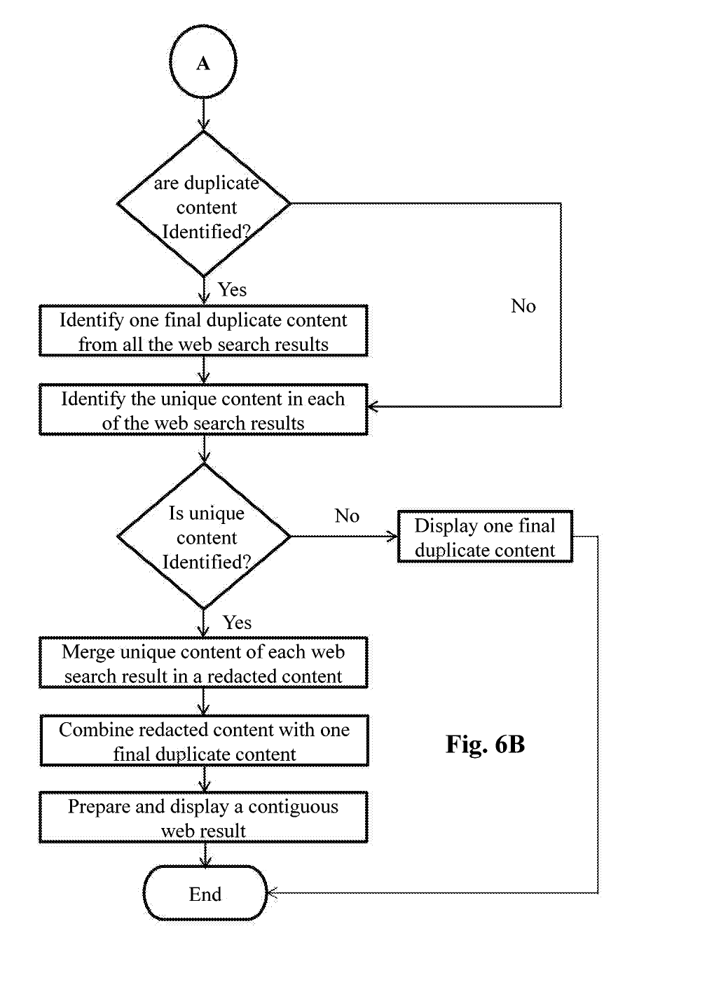

Once the searching is done at step 215 or 225, the method 200 flows to step A. The step A is explained more clearly in FIG. 5(b). After the steps 215 or 225, the present method 200 processes the search results and removes any duplicate content/information as mentioned in step 230. At step 235, the method 200 extracts relevant information or redacted content from the search results. The method 200 considers more than the first 10 search results for such extraction of redacted content.

At step 240, the method 200 merges these extracted pieces of information into one single contiguous web result and present this contiguous web result to the user 102 as mentioned in step 245.

In an embodiment, the method 200 searches for markers on the websites in order to provide more objective answers to the user. The examples of markers on websites include but not limited to common alphanumeric combination in different website links, tables, and words in the tables which are used commonly in different web pages. For example if the results to a query have information in a table layout in many of the results, the system may combine the tables, remove the duplicate information and then present the results.

The examples of markers on websites further include material information presented in a list format on different websites. For example for the search term “best movies all time”, provides many web pages which have lists of different movies which are all time best. In such a case, the present system and method is adapted to combine all such information i.e. all the lists into one unique list by removing the duplicate results from different list results and presenting one list result to the user. Here the system may show the names of movies which are mentioned the most number of times at the top of the results.

Yet another example is a search for “Microsoft balance sheet” may return the PDF or excel files of Microsoft's balance sheet directly as the search result.

Yet another example is a search for “Justin Timberlake photos”. Here if the system finds a minimum number of ‘photos’ of ‘Justin Timberlake’, then it directly displays images without displaying web links. Similarly the system would have pre-defined trigger words like “video” “audio” “mp3”, images, lyrics, poem, charts, which would show pictures, videos, play audios, lyrics, poems and charts as the case may be without having to resort to displaying web links.

Yet another example is a search for “download movie gone with the wind”. Here if the system finds an overwhelming and multiple number of hyper text links in multiple websites, the system will display the links directly as a results instead of displaying the web links.

In another embodiment, if the user searches for “lyrics pink Floyd money”, the system finds a pattern of lines where each line of one website matches the other and the words are identical. The words are displayed in separate lines instead of being contiguous. Where the words are contiguous than each line would not match the other line exactly. Here the system determines that it can safely display these lines as a result, so for the search term “lyrics pink Floyd money”, the lyrics of the song “Money” by “Pink Floyd” is directly displayed instead of displaying web links. The same may be the case with a user entering the search term “the woods are lovely dark and deep”. Here the system finds the same format where each line of each website matches the others (after removing html content), and the search term “the woods are lovely dark and deep” is part of the lines.

Similarly if the user enters a search term “Stephen Hawkins latest talks on YouTube”, the system would give an overwhelming weightage to the search term “YouTube” as it perfectly matches the name of a very popular website. Here instead of showing web links, the system would automatically go to YouTube in the background, enter the rest of the search term i.e. “Stephen Hawkins latest talks” and show the result on the YouTube website itself.

In another embodiment, say the user searches for “ideal BMI 21 year height 6′1” and the system finds multiple websites which have calculators or different fields in them. Then in such a case, the system will attempt to fill in the fields itself and make the calculation. In such a case if the system is not able to complete the calculation, then it will prompt the user to “enter weight in lbs” and then complete the calculation. Here the user experience is much better and easier as the user does not need to enter the data again in some of the fields and instead of taking a user to a new website with a new layout, font style, etc. the system would simply ask the user for the missing data and show the results on the display page itself.

Hence, the internet searching as disclosed herein has multiple benefits; (a) user convenience the user would get used to this kind of searching and would be encouraged to provide all the details (in this case the user did not enter weight lbs) as user would know that the system is most likely going to understand the user's queries (b) the user does not have to enter the details twice (c) the user does not have to get used to a new website format (d) the user is presented with all the relevant data in a pre-defined format, font and style which the user is used to.

Further the system is adapted to show the results based on the user's IP location. For example, a user searching in India is shown with the options in kilograms (kg) while a user searching in USA is shown with the options in Pound (lb).

In another embodiment, the user searches for “best pill cutter” and the results on multiple websites in the results are in a standard form. Such standard form include a photo of reasonably large size at the top of the page, and other indicators like price, ratings and shopping cart, then the system would directly show these pictures alongwith the price and rating. The display of this may be in any format like comparing the various results, displaying the results vertically or horizontally or any other suitable format.

In another embodiment, if the system finds multiple types of markers for the search term such as like videos, photos, text and the like markers. Then in such a situation, the system displays the results by dividing the result screen into photos, videos and text. These results can be displayed in any suitable formatting.

In another embodiment, the user searches for “Bawri patent”. The system finds a hyper link “Method and systems for searching and ranking electronic mail based on pre-defined algorithms, and the text on the page in the hyperlink matches a certain pre-defined percentage, for example 90% and also the words match contiguously in the results, then the page which the hyperlink leads to, is displayed directly.

Similarly, the method 200 is capable of finding information related to queries like “Microsoft share price last 10 years” by searching the fields directly and attempting to provide the results. For example, the present method may search a financial data engine such as Yahoo finance by entering Microsoft under company name and setting the years to 10. Hence, there is no need for users to do the manual work on a financial website for setting the company name as Microsoft, and time range of 10 years to find the results of such an extended search query such as the above.

Through this mechanism, the present method is able to present the information as found on different web sites in a single contiguous web result. Further, the present method is capable to provide quality information to the user from hundreds of web-links which are rarely accessed by the user.

In another embodiment of the present disclosure, the present method culls information from hundreds of websites:

by finding the top links across various search engines by calculating an the number of times a web link has been shown in the results of say search engines like Bing, Yahoo and Google and at which position and accordingly calculating a score for the same.

by attempting to find an objective answer to the users' search query from the contents of the webpages of various websites;

by calculating objective information from various webpages such as stock returns, flight bookings by using various search fields in the website itself. For example, the website www.expedia.com would have various search fields for searching for flight details, like From/Origin, To/Destination, Date, Fare, etc. As an example the user may enter the following search query for flights “New York San Francisco cheapest airfares”. The system would then attempt to find matching query fields within Expedia and/or other travel portals. The system would be able to understand different places from a pre-defined database.

The information which is retrieved after culling is then separated and presented based on whether the website is a commercial website, or a corporate website, or an ecommerce website, or a local or global website, or an informational website, a blog, or a news website. In an embodiment, these website are marked via the URL of the search results matching with the search term as in the case of “IBM” as the search term which would mark IBM company webpage as a homepage. In an embodiment, the websites which have and do not have a shopping cart and/or payment page are used as another marker to separate commercial websites from non-commercial websites. In an embodiment, the information culled from these websites is itself useful to separate local and international based websites. Additionally, while searching and presenting the search results to the user, the present method also considers factors including but not limited to the users search history, user preferences, user location, user age and user gender for culling and extracting the information of a particular website.

Hence, the present disclosure is adapted to directly present the most relevant snippets of various websites to the user. While the various embodiments of the invention have been illustrated and described, it will be clear that the invention is not limited to these embodiments only.

The computer implemented method for targeted web search over the computing web-network as disclosed in the present disclosure provides faster computation time, reduces the processing burden on processing elements of a computer, and increases the quality of search information as presented to the user. The disclosed searching algorithms which are based on identification of context of the inputted search term and the subsequent algorithm for identifying the duplicate information and culling the such duplicate information, and then redacting all the search results into one single search result eases the computing load on a computer processor and significantly increases the relevance of information as presented to the user.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

The system, as described in the disclosed teachings or any of its components, may be embodied in the form of a processor based system. Typical examples of a processor based system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings. Moreover, it would be clear that the ideas and algorithms need not be limited to already invented or developed areas like the world wide web and may be used for future discoveries too.

In a computer system comprising a general-purpose computer, such may include an input device, and a display unit. Specifically, the computer may include a microprocessor, where the microprocessor is connected to a communication bus. The computer may also include a memory the memory includes Random Access Memory (RAM) and Read Only Memory (ROM). The computer system further includes a storage device, wherein the storage device can be a hard disk drive or a removable storage drive such as a floppy disk drive, optical disk drive, and the like. The storage device can also include other, similar means for loading computer programs or other instructions into the computer system.

The computer system may include a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

The computer system executes a set of instructions that are stored in one or more storage elements in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the disclosed teachings. The set of instructions may be in the form of a software program.

An example Pseudo code of such instructions is referenced hereinbelow:

```
term=GetSearchTerm( );
Boolean IsQuestion=CheckQuestion(term)
If IsQuestion=true
  String data=GetExpertResult(term)
  If data!=null
    print data
    exit;
  data=GetUserResult(term)
  If data!=null
    print data
    exit;
Else
  String data=GetExpertResult(term)
  If data!=null
    print data
  data=GetUserResult(term)
  If data!=null
    print data
End If
data=GetCategoryResult(term)
If data!=null
  print data
data=GetFormatResult(term)
If data!=null
  print data
data=GetMatchedText(term)
If data!=null
  print data
  exit;
print 10 top links
Function CheckQuestion(term)
  If term contains “what | why | where | who | when”
    return true
  Else
    return false
End Function
Function GetExpertResult(term)
  String word=Remove questions and common words from term
  If word match expertdatabase
    return result
  Else
    return null
End Function
Function GetUserResult(term)
  String word=Remove questions and common words from term
  If word match userdatabase
    return result
  Else
    return null
End Function
Function GetCategoryResult(term)
  String word=Remove questions and common words from term
  If word match category
    Array APIs= matchedcatagory
    String result= GetData(APIs)
    return result
  Else
    return null
End Function
Function GetFormatResult(term)
  String word=Remove questions and common words from term
  If word match TableAndListDatabase
    return result
  Else
    return null
End Function
Function GetMatchedText(term)
  String word=Remove questions and common words from term
  Array Links= GetTop10Link(word)
  Array Words= FilterMostRepeatWords(Links)
  If words. count>0
    Array Sentences=GetTopHeadingSentences(Links,words)
    return Sentences
  Else
    return null
End Function
```

The software may be in various forms such as system software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs containing the set of instructions embodied therein. The processing of input data by the processing machine may be in response to user commands or in response to the results of previous processing or in response to a request made by another processing machine.

What is claimed is:

1. A computer-implemented method for targeted web search over a computing web-network, the method comprising:
receiving at least one input search term from a user computing device being used by the user;
identifying at least one search context corresponding to the input search term;
searching the input search term over a plurality of internet servers, the said plurality of internet servers being connected with the user computing device via an online platform;
identifying one or more web results from the plurality of internet servers;
processing each of the said identified web results to identify a duplicate content and a unique content present there-within; and
presenting the identified duplicate content and unique content to the user via the user computing device.

2. The computer-implemented method as claimed in claim 2, wherein processing each of the said identified web results comprises:
removing the identified duplicate content from each of the said web results to identify one final duplicate content;
merging the unique content for each of the said web results to obtain a redacted content;
combining the said redacted content for each of the web results with the said final duplicate content to form a contiguous web result corresponding to a predefined presentation format; and
presenting the contiguous web result over a graphical user interface of the user computing device.

3. The computer-implemented method as claimed in claim 2, wherein merging the redacted content comprises merging the said plurality of unique information sets alongwith the at least one of said content into the contiguous web result.

4. The computer-implemented method as claimed in claim 1, wherein the one or more web results correspond to at least one of the said search term, or the said identified search context.

5. The computer-implemented method as claimed in claim 1, wherein the input search term is at least a word, an alphabet, a number, a digit, a sentence, a sign, a mark, a picture, an audio, a video, a special character or a combination thereof.

6. The computer-implemented method as claimed in claim 1, wherein the search to context is at least a person name, name of a place, a geographical location, a mathematical formula, a domain name, a company name, a movie, a song, a book, a concept, a theory, a place and a combination thereof.

7. The computer-implemented method as claimed in claim 1, wherein the one or more web results are selected from at least one or more data files, a web page, a file from a data repository, and a file from a network server.

8. The computer-implemented method as claimed in claim 1, wherein the duplicate content is identified by analyzing similarity of at least one of a sequence pattern, a marker and a text match over one or more web results.

9. The computer-implemented method as claimed in claim 8, wherein the sequence pattern is a word sequence pattern, a number sequence pattern, a sign sequence pattern, a sentence sequence pattern, a picture sequence pattern, an audio sequence pattern, a video sequence pattern and a combination thereof.

10. The computer-implemented method as claimed in claim 1, wherein the duplicate content is identified by using calculation field in one or more web results.

11. The computer-implemented method as claimed in claim 1, wherein the unique content is identified by analyzing uniqueness of a sequence pattern over one or more web results.

12. The computer-implemented method as claimed in claim 1, wherein the unique content comprises: at least information related to the search term and the search context, and at least one sequence pattern of the duplicate content.

13. The computer-implemented method as claimed in claim 2, wherein the one contiguous result comprises a single web result having information extracted from one or more web results.

14. The computer-implemented method as claimed in claim 2, wherein the one contiguous result comprises:
at least the redacted content for each of the said web results, and at least one sequence pattern of the duplicate content.

15. The computer-implemented method as claimed in claim 1, wherein the predefined presentation format is based on the search context of the search term.
